(19) United States
(12) Patent Application Publication
(10) Pub. No.: US 2016/0049170 A1
(43) Pub. Date: Feb. 18, 2016

(54) OPTICAL INFORMATION RECORDING AND RECONSTRUCTING DEVICE

(71) Applicant: HITACHI CONSUMER ELECTRONICS CO., LTD., Tokyo (JP)

(72) Inventor: Kouji FUJITA, Tokyo (JP)

(21) Appl. No.: 14/782,891

(22) PCT Filed: Apr. 10, 2013
(86) PCT No.: PCT/JP2013/060772

§ 371 Date: Oct. 7, 2015

(51) Int. Cl. G11B 7/1353; G03H 1/22; G11B 7/1374; G03H 1/26

(52) U.S. Cl. CPC G11B 7/1353; G03H 1/2645; G03H 1/2205; G03H 1/2286; G11B 7/1374; G03H 2001/2207; G03H 2001/2675; G03H 2001/221

(57) ABSTRACT

During reconstruction, the hologram cannot be reconstructed at high speed. In the present invention, the distance between the optical system base point, which is associated with a recording medium address during recording, and the recording medium is measured, and said distance is recorded in a memory. During reconstruction, distance information, which is the distance of the recording medium from the memory that is associated with a recording medium reconstruction address, is read, and the position of an aperture filter is adjusted at high speed in the optical axis direction on the basis of the read distance information and a distance measurement result for the optical system base point during reconstruction and the recording medium. Thus, the relative positions of the hologram within the recorded medium associated with the optical system during reconstruction and during recording can be matched.

### TECHNICAL FIELD

The present invention relates to an optical information recording and reconstructing device that records information on an optical information recording medium by using an interference pattern of a signal beam and a reference beam as page data and/or reconstructing information from the optical information recording medium.

### BACKGROUND ART

Also for consumer users, commercial realization of an optical disk having a recording density of 128 GB has become possible with BD (Blu-ray Disc) standards. On the other hand, the needs for further large-capacity archive storages are increasing, and an optical storage is desired to increase the capacity thereof to 1 TB or higher. While next-generation optical storage techniques are studied, hologram recording techniques capable of realizing large-capacity recording and reconstructing at high speed by utilizing holograms have drawn attention. The hologram recording techniques are the techniques of optically recording information on a recording medium by overlapping a signal beam, which has page data information which is information two-dimensionally modulated by a spatial light modulator, with a reference beam in the recording medium and generating refractive index modulation in the recording medium by the interference fringes pattern generated at that point. In a case of reconstruction of the information, the recording medium is irradiated with the reference beam used in the case of recording; as a result, the hologram recorded in the recording medium works like diffraction grating and generates diffraction light, and the diffraction light is reconstructed as the same light including the recorded signal beam and phase information. The reconstructed signal beam is two-dimensionally detected at high speed by using an image sensor. Characteristics of the hologram recording and reconstructing techniques reside in that two-dimensional information can be recorded on and reconstructed from an optical recording medium by one hologram and that multiplexed recording onto the same part of the recording medium can be carried out; therefore, large-capacity and high-speed transfer can be realized.

Examples of the hologram techniques include JP-A-2007-293238 (Patent Literature 1). This publication describes “an optical information reconstructing device using a hologram, having a driving unit that changes the distance between an optical information detector and an objective lens; wherein, the optical information reconstructing device adjusts focusing of a detection image, which is detected by the optical information detector, by changing the distance”.

### CITATION LIST

### Patent Literature

### PATENT LITERATURE 1: JP-A-2007-293238

### SUMMARY OF INVENTION

### Technical Problem

Patent Literature 1 is a technique in which, upon reconstruction of hologram data, a hologram reconstructing beam is subjected to focus adjustment with respect to a two-dimensional image sensor. In recording/reconstructing of a two-light-flux page multiplex-type hologram, a reference beam and a signal beam are overlapped with each other, and interference of the beams is recorded onto the recording medium; therefore, it is difficult to mount an optical focus adjustment mechanism. Therefore, in recording of a hologram, every time the recording position of the medium is changed, the distance between an objective lens and the recording medium is varied due to distortion of the recording medium, surface wobbling due to deformation, and mechanical tolerances; therefore, the hologram position (height) is varied in the thickness direction in the recording medium and recorded thereat. In order to reconstruct this hologram, the height from the objective lens to the hologram in the recording medium has to be detected. However, the height to the hologram cannot be physically detected. Moreover, in order to optically detect the hologram height, correct movement to the recording position of the hologram serving as a reconstruction target has to be carried out, the conditions under which a hologram reconstruction beam is obtained such as a Bragg angle of the reference beam and the wavelength of the reference beam have to be satisfied, and time is required to start focus adjustment. Therefore, the speed of reconstruction cannot be improved.

Therefore, an object of the present invention is to speed up the reconstruction speed of the hologram.

### Solution to Problem

The above described problems can be solved by the invention described, for example, in claims.

### Advantageous Effects of Invention

According to the present invention, the reconstruction speed of the hologram can be speeded up.

### BRIEF DESCRIPTION OF DRAWINGS

FIG. 1 is a drawing showing Embodiment 1 of the present invention.

FIG. 2 is a drawing showing Embodiment 2 of the present invention.

FIG. 3 is a drawing showing a mechanism of changing the height of a recording medium of Embodiment 2 of the present invention.

FIG. 4 is a drawing showing an optical-height measurement result memory with respect to a recording location.

FIG. 5 is a drawing showing a defocus state and a defocus-adjustment completed state of a polytopic filter.

FIG. 6 is a block diagram showing a recording and reconstructing device.

FIG. 7 is an operation flow in a case of recording of Embodiment 1.

FIG. 8 is an operation flow in a case of reconstruction of Embodiment 1.

FIG. 9 is an operation flow in a case of recording of Embodiment 2.

FIG. 10 is an operation flow in a case of reconstruction of Embodiment 2.

### DESCRIPTION OF EMBODIMENTS

Hereinafter, Examples of the present invention will be explained by using drawings.

### Example 1

An embodiment of the present invention will be explained based on accompanying drawings.

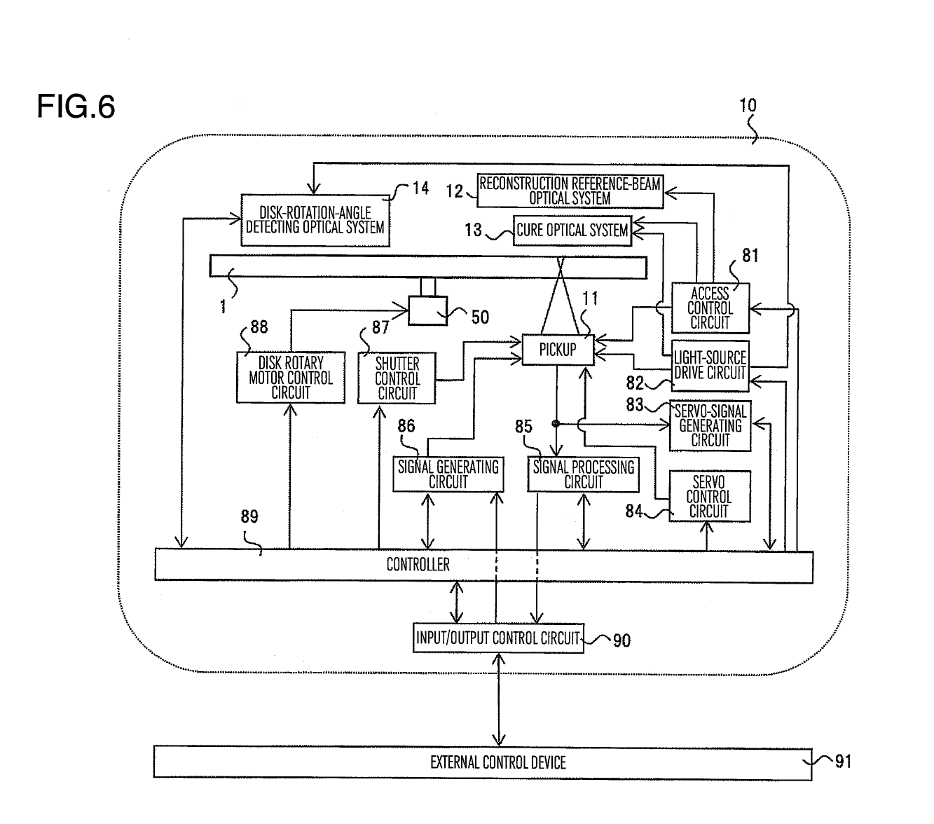

FIG. 6 is a block diagram showing a recording and reconstructing device of an optical information recording medium which records and/or reconstructs digital information by utilizing holography.

An optical information recording and reconstructing device 10 is connected to an external control device 91 via an input/output control circuit 90. If recording is to be carried out, the optical information recording and reconstructing device 10 receives information signals for recording from the external control device 91 by the input/output control circuit 90. If reconstructing is to be carried out, the optical information recording and reconstructing device 10 transmits reconstructed information signals to the external control device 91 by the input/output control circuit 90.

The optical information recording and reconstructing device 10 is provided with a pickup 11, a reconstruction reference-beam optical system 12, a cure optical system 13, a disk-rotation-angle detecting optical system 14, and a rotary motor 50, and an optical information recording medium 1 is configured to be rotatable by the rotary motor 50.

The pickup 11 plays a role of irradiating the optical information recording medium 1 with a reference beam and a signal beam and recording digital information on the recording medium by utilizing holography. In this process, the information signals to be recorded are transmitted to a spatial light modulator in the pickup 11 via a signal generating circuit 86, and the signal beam is modulated by the spatial light modulator.

If the information recorded on the optical information recording medium 1 is to be reconstructed, optical waves which enter the optical information recording medium in the direction opposite to that in the case in which the reference beam emitted from the pickup 11 is recorded are generated by the reconstruction reference-beam optical system 12. The reconstruction beam reconstructed by the reconstruction reference beam is detected by a later-described photodetector in the pickup 11, and the signals are reconstructed by a signal processing circuit 85.

The irradiation time of the reference beam and the signal beam, which irradiates the optical information recording medium 1, can be adjusted by controlling the open/close time of a shutter in the pickup 11 by a controller 89 via a shutter control circuit 87.

The cure optical system 13 has a role to generate optical beams which are used in pre-cure and post-cure of the optical information recording medium 1. The pre-cure is a preceding process in which, when information is to be recorded at a desired position in the optical information recording medium 1, the desired position is irradiated with a predetermined optical beam in advance before irradiation with the reference beam and the signal beam. The post-cure is a post-process in which, after information is recorded at a desired position in the optical information recording medium 1, the desired position is irradiated with a predetermined optical beam in order to make it non-recordable.

The disk-rotation-angle detecting optical system 14 is used for detecting the rotation angle of the optical information recording medium 1. If the optical information recording medium 1 is to be adjusted to a predetermined rotation angle, signals corresponding to the rotation angle are detected by the disk-rotation-angle detecting optical system 14, and the rotation angle of the optical information recording medium 1 can be controlled by the controller 89 by using the detecting signals via a disk rotary motor control circuit 88.

Predetermined light-source drive currents are supplied from a light-source drive circuit 82 to light sources in the pickup 11, the cure optical system 13, and the disk-rotation-angle detecting optical system 14, and light beams can be emitted by predetermined light intensities from the light sources.

Moreover, the pickup 11 and the disk cure optical system 13 are provided with mechanisms capable of sliding the positions thereof in the radial direction of the optical information recording medium 1, and position control is carried out via an access control circuit 81.

Meanwhile, the recording techniques utilizing the angle multiplexed principles of holography have a tendency that the allowable error with respect to misalignment of the reference beam angle becomes extremely small.

Therefore, a mechanism which detects the misaligned amount of the reference beam angle has to be provided in the pickup 11, signals for servo control have to be generated in a servo-signal generating circuit 83, and a servomechanism for correcting the misaligned amount via a servo control circuit 84 has to be provided in the optical information recording and reconstructing device 10.

The pickup 11, the cure optical system 13, and the disk-rotation-angle detecting optical system 14 may be simplified by integrating some of the optical system configurations or all of the optical system configurations into one.

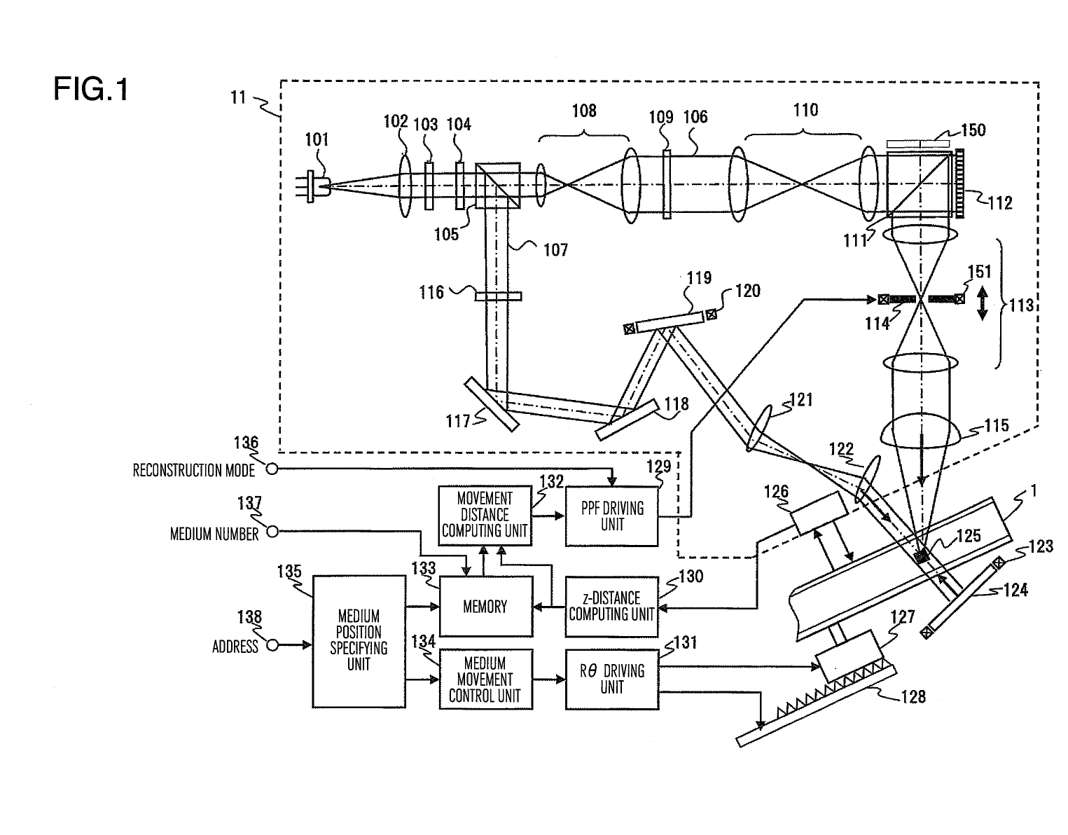

FIG. 1 shows an example of the optical system configurations of the optical pickup 11 in the optical information recording and reconstructing device 10 of the present invention. First, a recording procedure of hologram will be explained. The optical beam emitted from a light source 101 transmits through a collimate lens 102 and enters a shutter 103. When the shutter 103 is open, the optical beam passes through the shutter 103, then, after the polarization direction thereof is adjusted by an optical element 104 consisting of a half-wavelength plate so that the light intensity ratio of P polarization and S polarization becomes a desired ratio, enters a PBS (Polarization Beam Splitter) prism 105. The optical beam which has transmitted through the PBS prism 105 works as a signal beam 106, subjected to expansion of an optical beam diameter by a beam expander 108, then enters a phase mask 109, relay lenses 110, and a PBS prism 111, and enters a spatial light modulator 112. The signal beam to which information has been added by the spatial light modulator 112 is reflected by the PBS prism 111 and propagates through relay lenses 113 and a polytopic filter 114. Then, the signal beam is collected onto the optical information recording medium 1 by an objective lens 115.

On the other hand, the optical beam reflected by the PBS prism 105 works as a reference beam 107, is set to have a predetermined polarized direction depending on a recording case or a reconstructing case by a polarization-direction converting element 116, and then enters a galvano-mirror 119 via a mirror 117 and a mirror 118. The galvano-mirror 119 adjusts the optical axis angle of the reference bam by adjusting the angle of the mirror by an actuator 120, and the reference beam passes through a lens 121 and a lens 122 and then enters the recording medium 1. In this manner, the signal beam and the reference beam are caused to enter by overlapping with each other in the recording medium 1, thereby forming an optical interference fringes pattern (hologram) 125, and information is recorded by exposing this pattern to the recording medium 1. Moreover, since the incident angle of the reference beam, which enters the recording medium 1, can be changed by the galvano-mirror 119, multiplexed recording on the same part of the recording medium can be carried out.

In a method of recording the interference pattern of light by overlapping two light fluxes, the depth (height) at which the hologram 125 is recorded in the recording medium 1 is uniquely determined depending on the distance (optical height) between an optical reference point of the optical pickup 11 such as the objective lens 115 and the surface of the recording medium 1. However, every time the recording medium 1 is moved, the distance (optical height) between the objective lens 115 and the surface of the recording medium 1 does not become a constant value. Hereinafter, the recording medium 1 will be explained to have a disk shape in terms of explanation of operations, but is not limited thereto.

When the recording medium is rotated, surface wobbling occurs, and the optical height is varied. The height in the zone of movement of the recording medium 1 from an inner periphery to an outer periphery in a radial direction is varied by a mechanical tolerance. Therefore, every time a recording location is changed with respect to the recording medium 1, the depth at which the hologram 125 is recorded is varied in the thickness direction (depth) in the recording medium 1.

Next, a reconstructing procedure of hologram will be explained. The reference beam 107 is caused to enter the recording medium 1, and the optical beam which has transmitted through the recording medium 1 is reflected by a galvano-mirror 124, which can adjust an angle by an actuator 123, thereby generating a reconstruction reference beam. A reconstruction beam reconstructed by the reconstruction reference beam propagates to the objective lens 115, the relay lenses 113, and the polytopic filter 114. Then, the reconstruction beam transmits through the PBS prism 111 and enters an optical detector 150, and the recorded signals can be reconstructed. For example, an image pickup element can be used as the optical detector 150. However, any element may be used as long as page data can be reconstructed.

In order to cause the reconstruction beam to correctly form an image on the optical detector 150, the distance (reconstruction optical height) between the hologram 125, which is recorded in the recording medium 1, and the optical reference point of the optical pickup 11 such as the objective lens 115 has to have predetermined accuracy such as ±12 μm or less with respect to a predetermined value such as 3 mm.

In order to reconstruct the hologram 125, the hologram 125 present in the thickness direction (depth) in the recording medium 1 has to be detected. However, there is no method to physically detect it. On the other hand, there is a method to optically detect it; however, optical conditions under which the reconstruction beam from the hologram 125 is obtained such as Bragg angle conditions of the reference beam, wavelength conditions of laser, and pitch angle conditions of the recording medium and the reference beam have to be satisfied. In order to realize high-speed reconstruction, even in a state in which the reconstruction beam from the hologram 125 cannot be obtained, the above described reconstruction optical height has to be best adjusted.

Therefore, Example 1 is configured to equivalently realize reconstruction optical height adjustment by reproducing the optical height of the case of recording of the hologram 125. Hereinafter, the configuration thereof will be explained. In recording, a location to record the hologram 125 is specified on the recording medium. Hereinafter, the recording medium 1 will be explained to be circular as an example, but may have any medium shape.

Address values representing physical recording locations are allocated to the recording medium 1 in advance. Based on the addresses, the rotation angle (θ) and radial position (R) of the recording medium 1 are associated to carry out physical position information conversion, a spindle motor 127 is rotated by the angle θ, and a radial movement stage 128 is subjected to R thread movement, thereby carrying out positioning to a recording location of a target address. The above described positioning to the recording location may be carried out by orthogonal coordinates of an X axis and a Y axis of the recording medium. Hereinafter, a positioning operation will be explained by taking the positioning by the rotation angle (θ) and the radial position (R) of the recording medium 1 as an example.

When a recording address is input from an input terminal 138, the rotation angle (A) and the radial position (R) of the recording medium 1 are converted in association with the address by a medium position specifying unit 135 and are transmitted to a medium movement control unit 134. The medium movement control unit 134 calculates the rotary movement distance and thread movement distance from the current rotation angle (θ) and the radial position (R) to the target rotation angle (θ) and the radial position (R) and transmits the calculation results thereof to an Rθ driving unit 131. The Rθ driving unit 131 carries out recording positioning of the recording medium 1 by rotating the spindle motor 127 and subjecting the radial movement stage 128 to R thread drive.

Then, when recording positioning is completed, the distance (optical height) from the optical reference point to the surface of the recording medium 1 is measured by a distance meter 126, which is provided at the optical reference point of the pickup 11. The distance meter 126 is an optical distance meter utilizing surface reflection of the recording medium 1, for example, but is not limited thereto and may be any measurement means as long as the distance from the optical reference point to the surface of the recording medium 1 can be measured. The optical height measures the surface position of the recording medium 1 on which the hologram 125 is recorded or a location close to the surface position. The measurement signal from the distance meter 126 is transmitted to a z-distance computing unit 130, and the value of the optical height is computed. The value of the optical height is transmitted to a memory 133. On the other hand, the specified address is transmitted to the memory 133 via the medium position specifying unit 135. The memory 133 stores the optical height measurement result in association with the specified address (recording location).

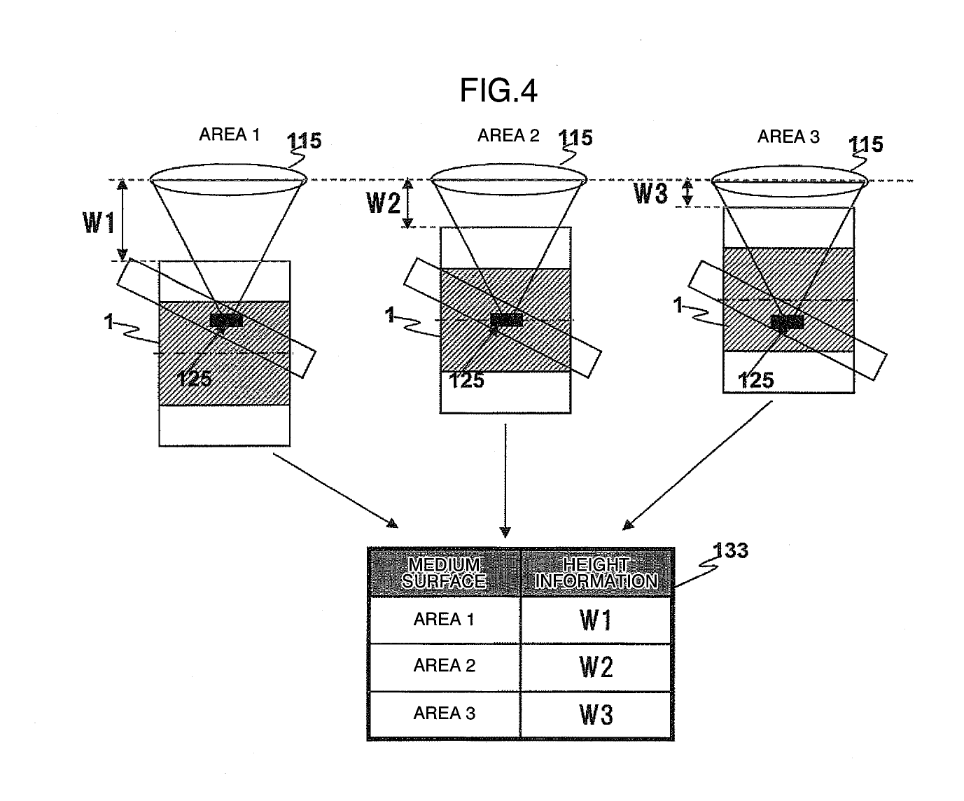

FIG. 4 shows a conceptual diagram of storage of the optical height measurement results with respect to recording locations (areas). Corresponding to all of hologram recording locations (books) on the recording medium, the optical height measuring operation and the operation to store the measurement results are carried out; wherein, the optical height measuring operation and the operation to store the measurement results may be carried out while assuming a plurality of books as one region (area). Since the size of the hologram 125 with respect to the recording medium 1 is extremely small, for example, a square size of 760 μm×380 μm; therefore, if the changed distance of the optical height with respect to the recording location corresponding to the plurality of books is equal to or less than defocus adjustment specifications, which are for example ±12 μm, it is particularly effective and rational. Hereinafter, the operations of Examples will be explained on the assumption of the addresses of respective books. However, if a predetermined area of the address is a region in which a predetermined number of holograms are aggregated, for example, in a Cure site unit (for example, a region of 80×80 holograms) for carrying out Cure or in a bookcase unit (for example, region of an integral number of Cure sites) and is in a unit in which the number of holograms is aggregated in terms of processing and sequences particularly about recording, management is easy, which is desirable. Moreover, the number of holograms in the area is not limited, but may be any number depending on the physical state of the recording medium.

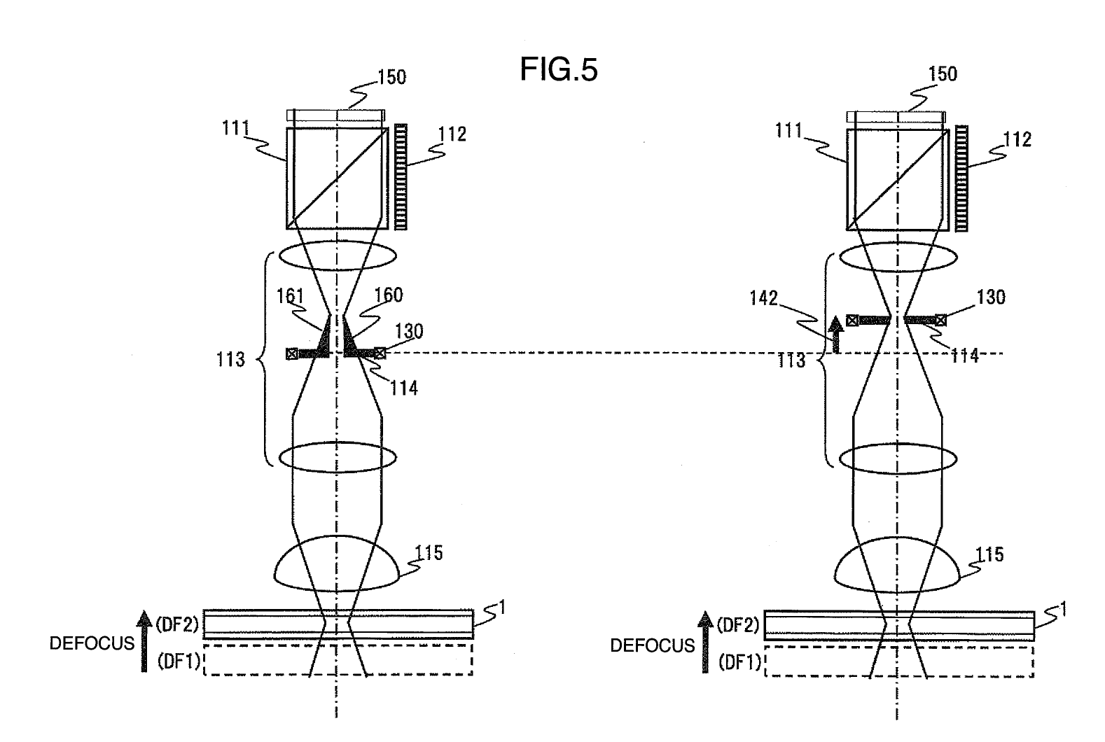

In an area 1 of FIG. 4, the measurement result of the distance (optical height) between the objective lens 115 and the surface of the recording medium 1 is (W1). Subsequently, an area 2 in which the hologram 125 is then recorded is in a state in which the recording medium 1 is close to the objective lens 115, and the measurement result of the distance (optical height) between the objective lens 115 and the surface of the recording medium 1 is (W2). Furthermore, an area 3 in which the hologram 125 is then subsequently recorded is in a state in which the recording medium 1 is further close to the objective lens 115, and the measurement result of the distance (optical height) between the objective lens 115 and the surface of the recording medium 1 is (W3). Regarding the height (depth) at which the holograms 125 in the recording medium 1 are recorded, the hologram is recorded at a position above the center of the recording medium thickness in the area 1, the hologram is recorded in the vicinity of the recording medium thickness in the area 2, and the hologram is recorded at a position below the center of the recording medium thickness in the area 3. The optical height information measured for each of the areas is stored into the memory 133 in association with the respective measurement areas. As a management method of an area, for example, class management in which a plurality of book addresses belong to the area may be used. The memory 133 is stored in a memory 133 provided in the unshown optical information recording and reconstructing device. At this point, recording medium unique numbers are stored in association. The unique number of the recording medium 1 is added to the recording information of the spatial light modulator 112 and is recorded as management information of the recording medium 1. Then, a mode of reduction of the reconstruction signal quality with respect to defocusing in the case of reconstruction will be explained by using FIG. 5. The polytopic filter 114 is an optical filter for blocking the reconstruction beam from the holograms next to a target reconstruction hologram, consists of a through hole optically having the same shape and size as the hologram size, and can be realized by a thin light material. The polytopic filter 114 is disposed at a light collection position of the relay lenses 113 and allows passage of only the reconstruction beam from the target hologram. Hereinafter, the operation of the optical filter will be explained by taking the polytopic filter as an example. However, it may be an optical filter, for example, an angle filter which has similar effects.

The left side of FIG. 5 shows part of the optical configuration in the case in which the recording medium 1 is defocused upon hologram reconstruction. The recording medium 1 shows an example of the case in which a position (DF1) before defocusing is changed to a position (DF2) after defocusing. In this case, the diffraction light from the hologram, which is desired to be reconstructed, generates positional misalignment in the defocusing direction relative with respect to the optical pickup, and parts (160 and 161 of FIG. 5) through which the diffraction light cannot partially pass are generated at the polytopic filter 114. As a result, part of a reconstructed image lacks, the light intensity is reduced, and a problem that reconstruction quality is reduced occurs. In order to solve this, there is a means to move the recording medium 1 to the position of defocusing (DF1) so as to achieve the same optical height as a recording case or a means to move the polytopic filter 114 per se by the amount of optical magnification corresponding to the above described defocusing distance as an optical defocusing distance in the optical axis direction. Herein, the means to move the polytopic filter 114, which can realize high-speed responsiveness, will be explained. However, the recording medium 1 may be moved to the position of defocusing (DF1).

The right side of FIG. 5 shows an optical mode of a case in which the polytopic filter 114 is moved (142) by the optical defocusing distance corresponding to the defocusing distance, for example, the defocusing distance multiplied by, for example, 10 which is the optical magnification. When the polytopic filter 114 is subjected to defocusing adjustment in the optical axis direction, the diffraction light from the hologram, which his desired to be reconstructed, passes through the polytopic filter 114, and a reconstructed image with which reconstruction signal quality is obtained can be projected to the optical detector 150. In other words, if the optical height in the case of recording can be reconstructed in the case of reconstructing, the reconstruction beam which passes through the polytopic filter can project the reconstructed image to the optical detector 150 in an optimum state.

Next, an operation of defocusing adjustment control in the case of reconstruction will be explained by using FIG. 1. In the case of reconstruction, when a reconstruction address is input from the input terminal 138, the rotation angle (θ) and the radial position (R) of the recording medium 1 are converted in association with the address by the medium position specifying unit 135 and are transmitted to the medium movement control unit 134. The medium movement control unit 134 calculates the rotary movement distance and the thread movement distance from the current rotation angle (θ) and radial position (R) to the target rotation angle (θ) and radial position (R) and transmits the calculation results thereof to the Rθ driving unit 131. The Rθ driving unit 131 rotates the spindle motor 127 and further subjects the radial movement stage 128 to R thread movement, thereby carrying out reconstruction positioning of the recording medium 1. When the reconstruction positioning is completed, the distance (optical height) between the optical reference point and the surface of the recording medium 1 is measured by the distance meter 126 provided at the optical reference point of the pickup 11. The measurement signal from the distance meter 126 is transmitted to the z-distance computing unit 130, and the value of the optical height is computed. The value of the optical height is transmitted to a movement distance computing unit 132. On the other hand, the reconstruction-specified address is transmitted to the memory 133 via the medium position specifying unit 135. The optical height information of the case of recording which is associated with the specified address or the areas classified by the address is read from the memory 133 and is transmitted to the movement distance computing unit 132. The movement distance computing unit 132 computes the difference between the optical height information of the case of reconstruction (present) and the optical height of the case of recording (past). As the optical-axis movement distance of the polytopic filter 130, the movement distance of the polytopic filter is computed by multiplying the difference value of the optical height by the optical magnification such as 10 times and is transmitted to a PPF driving unit 129.

The PPF driving unit 129 drives the polytopic filter in the optical axis direction by driving an actuator 151 by the amount of misalignment from the optical height of the case of reconstruction. The polytopic filter 114 carries out adjustment movement only in the case of reconstruction and is fixed a predetermined machine position in the case of recording. Therefore, a mode selecting signal, which indicates a reconstruction mode, is transmitted from an input terminal 136 to the PPF driving unit. As a result, the optical height of the case of recording can be adjusted to be optically equivalent to the optical height of the case of reconstruction. On the other hand, the polytopic filter 114 is configured to be movable in the case of reconstruction; therefore, in the case of recording, the polytopic filter 114 has to be fixed to the predetermined machine position. It is difficult to fix the movable polytopic filter; therefore, in the case of recording, a switching operation to a (unshown) second fixed recording polytopic filter, which does not have an actuator may be carried out. The memory 133 may be in the optical information recording and reconstructing device or in a higher-level management system connected to the optical information recording and reconstructing device.

The memory 133 stores each of the optical height information of a plurality of recording media. Therefore, unique numbers have to be allocated to the recording media, respectively, and the storage media have to be identified by the unique numbers of the recording media in the case of reconstruction. For example, the unique number of a recording medium can be identified by providing a semiconductor memory or a magnetic memory in a case (for example, cartridge) covering a (unshown) recording medium, recording the unique number of the recording medium in the memory, and reading it. In the memory, RFID may be buried in part of the recording medium to record a recording medium unique number, and a reading operation may be carried out. A host side to which the device is connected may be provided with the memory 133.

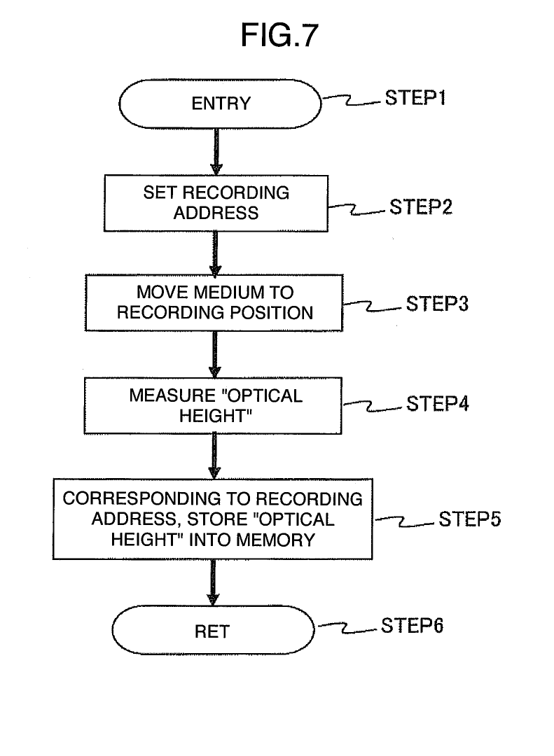

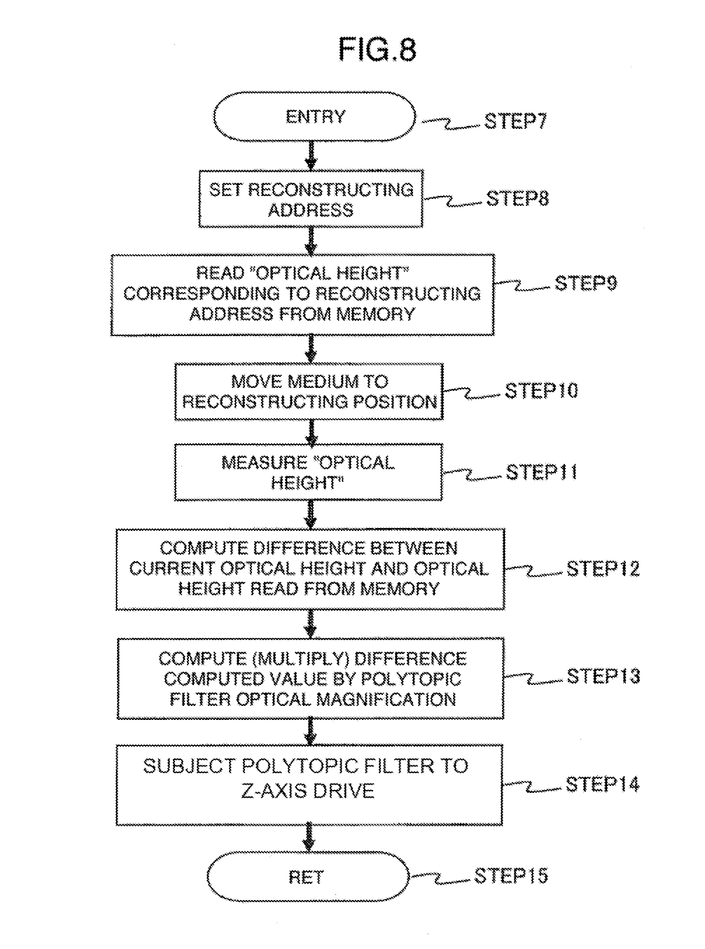

The operation flow in the case of recording of the first example above is shown in FIG. 7, and the operation flow in the case of reconstruction is shown in FIG. 8. First, a recording address of the medium 1 is set (STEP 1), and medium movement to the recording address is then carried out to complete positioning (STEP 3). Then, the optical height is measured (STEP 4), and the optical height information corresponding to the recording address is recorded on the memory (STEP 5).

On the other hand, in the reconstructing operation, a reconstructing address is set (STEP 8), and the optical height information of the case of recording corresponding to the reconstructing address is read from the memory (STEP 9). Then, medium movement to the reconstructing address is carried out to complete positioning (STEP 9). Then, measurement of the optical height is carried out (STEP 11), and the difference between the measurement result and the optical height of the case of recording read from the memory is computed (STEP 12). The difference computing result is multiplied by the optical magnification of the polytopic filter (STEP 13), and the polytopic filter is driven in a Z axis based on the computing result (STEP 14).

In the above described first example, defocusing adjustment in the case of reconstruction can be realized by reproducing the optical height of the case of recording by using the polytopic filter in the case of reconstruction. Moreover, since the polytopic filter is a light-weight optical member, the polytopic filter can be moved at high speed and can carry out defocusing adjustment at high speed in the case of reconstruction. Moreover, while the reconstructing position of the recording medium is being changed and moved, defocusing adjustment of the next reconstructing position can be carried out in parallel by using the polytopic filter. Furthermore, effects are large, for example, defocusing adjustment in the case of reconstruction can be carried out in a stage before the hologram reconstruction beam is obtained, in other words, in a state in which the reconstruction beam of the hologram is not obtained. By virtue of these effects, improvement of the reconstruction speed can be expected. Moreover, even in a case in which a recording device and a reproducing device are different, the effects can be exerted also in compatible reconstruction by causing the optical heights to mutually match in recording and reconstructing.

### Example 2

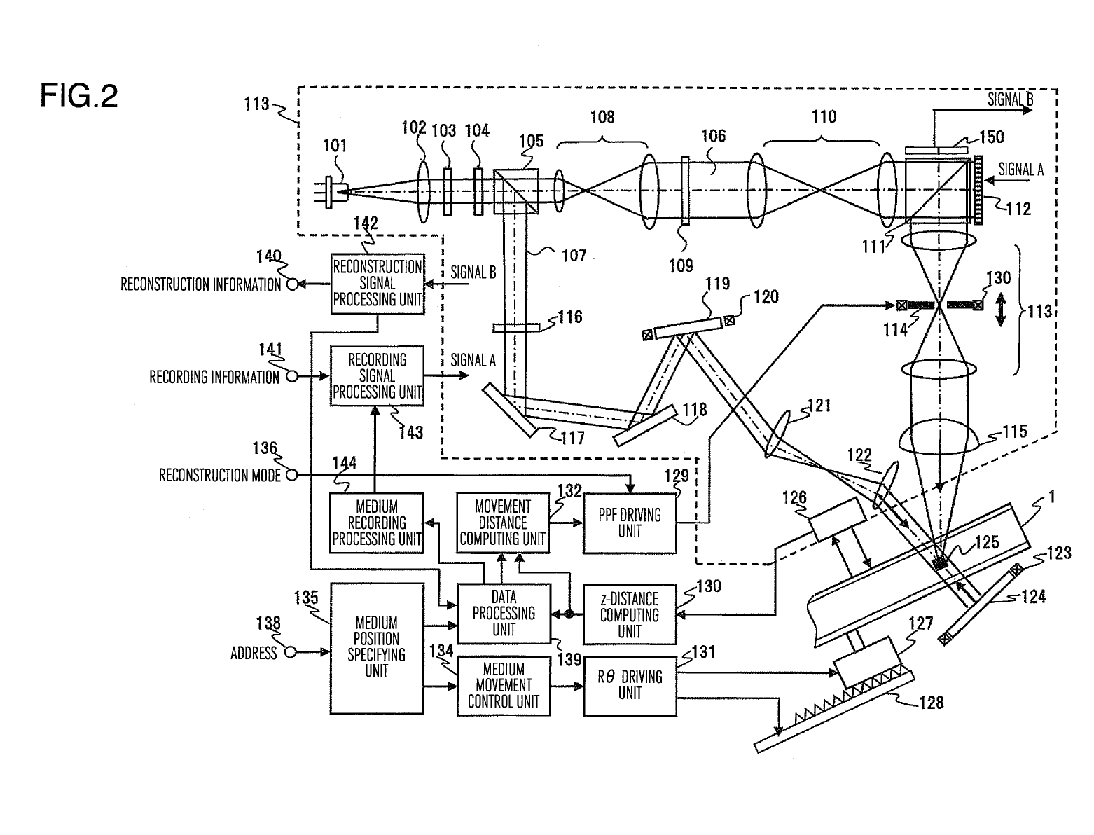

An embodiment of the present invention will be explained in accordance with FIG. 2. Explanation of the functional blocks which are the same as those of FIG. 1 will be omitted. In the present example, the optical height information of the case of recording corresponding to an address of the recording medium 1 is recorded into a management information region of the recording medium 1 and is reconstructed, and the operations thereof will be hereinafter explained by using FIG. 2.

First, in the operation in the case of recording, when a recording address is input from the input terminal 138, in the medium position specifying unit 135, the rotation angle (θ) and the radial position (R) of the recording medium 1 are converted in association with the address and are transmitted to the medium movement control unit 134. The medium movement control unit 134 calculates the rotary movement distance and the thread movement distance from the current rotation angle (θ) and radial position (R) to a target rotation angle (θ) and radial position (R) and transmits the calculation results thereof to the Rθ driving unit 131. The Rθ driving unit 131 rotates the spindle motor 127 and subjects the radial movement stage 128 to R thread movement, thereby carrying out recording position positioning of the recording medium 1.

Then, when the recording positioning is completed, the distance (optical height) between the optical reference point and the surface of the recording medium 1 is measured by the distance meter 126 provided at the optical reference point of the pickup 11. The measurement signal from the distance meter 126 is transmitted to the z-distance computing unit 130, and the value of the optical height is computed. The value of the optical height is transmitted to a data processing unit 139. The specified recording address is transmitted to the data processing unit 139 via the medium position specifying unit 135. The data processing unit 139 associates the optical height measurement result with the specified recording address, subjects that to table data processing, and transmits that to the medium recording processing unit 144. The medium recording processing unit 144 converts the recording address and the optical height information, which have been converted into the table data, to the data to be recorded onto the recording medium. The recording address and the optical height information, which have been generated by the medium recording processing unit 144 and converted into table data, are added to the recording information, which is input from an input terminal 141, by a recording signal processing unit 143, are input to the spatial light modulator 112 as a signal A, and optically generates hologram recording data, and the optical height information with respect to the recording address converted into the table data is recorded onto the recording medium 1 as management information of the recording medium 1. The optical heights in the case of recording and in the case of reconstruction of the management information will be explained below.

Regarding the address of the management information recording the optical height information, for example, the management information is recorded at an innermost peripheral position of the area at which the influence of rotation surface wobbling of the Disc is the smallest, and, regarding the optical height in this case, the recording medium 1 is driven to the optical axis direction (Z axis) determined in advance.

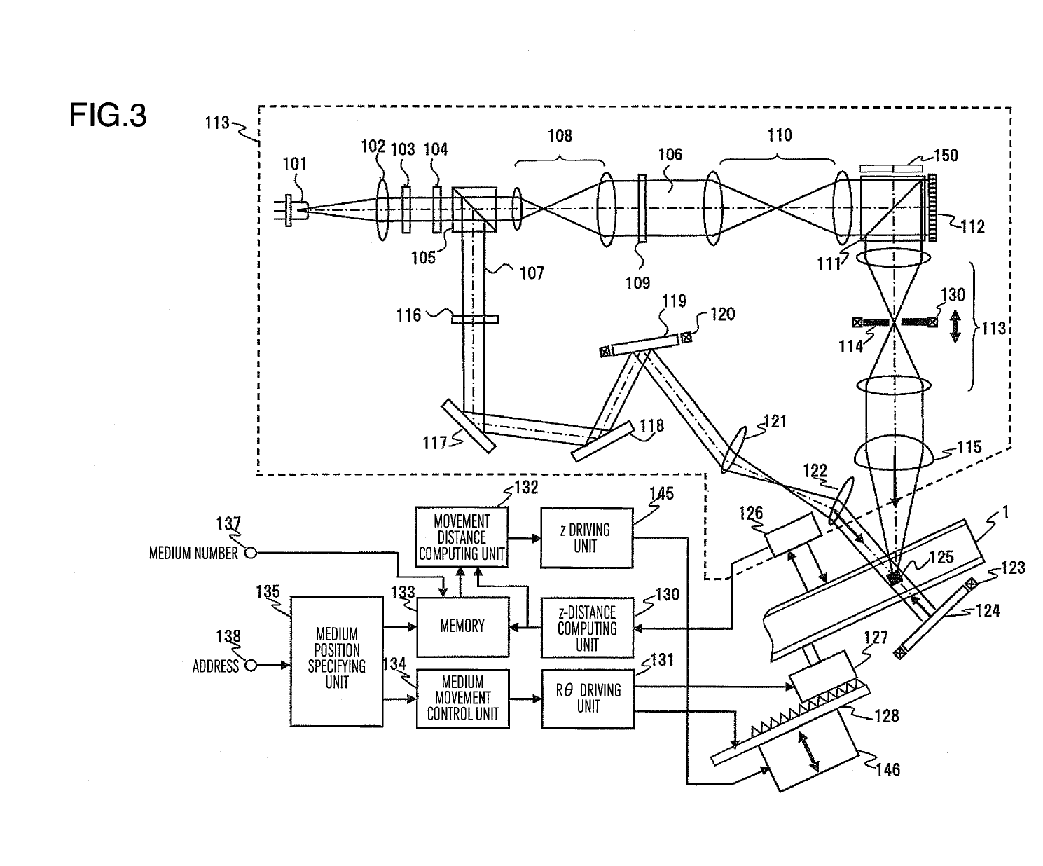

FIG. 3 shows a configuration diagram of movably control the recording medium in the Z-axis direction. The explanations of the functional blocks which are the same as those of FIG. 1 are omitted. The measurement signal from the distance meter 126 is transmitted to the z-distance computing unit 130, and the value of the optical height is computed. Regarding the optical height information, the difference from the optical height value of the case in which the management information is recorded is computed in the movement distance computing unit 132, and the computing information is transmitted to a z driving unit 145. The z driving unit 145 is driven to adjust the optical height to a value which is determined in advance by transmission to a Z-axis stage actuator 146, which can move the recording medium 1 in the Z-axis direction. Regarding this operation, similar operations are carried out both upon recording and reconstructing. As a result, regarding important management information, the optical height can be physically equalized in recording and reconstructing without the need of the optical height information of the case of recording.

Next, returning to FIG. 2, a reconstructing operation of the optical height information with respect to the reconstructing address of the recording medium 1 will be explained. The reconstructing beam of the hologram 125 enters the optical detector 150, and the image information thereof is transmitted to a reconstruction signal processing unit 142 as a signal B. The reconstructing signal processing unit 142 outputs a reconstruction information signal to an output terminal 140 and transmits the optical height information with respect to an address of the recording medium to the data processing unit 139. When the data processing unit 139 obtains the optical information with respect to the address about the recording medium 1, the data processing unit 139 thereafter carries out the same functional operations as the memory 133 of above described FIG. 1, and, thereafter, a calculating operation and driving of the driving distance of the polytopic filter are carried out.

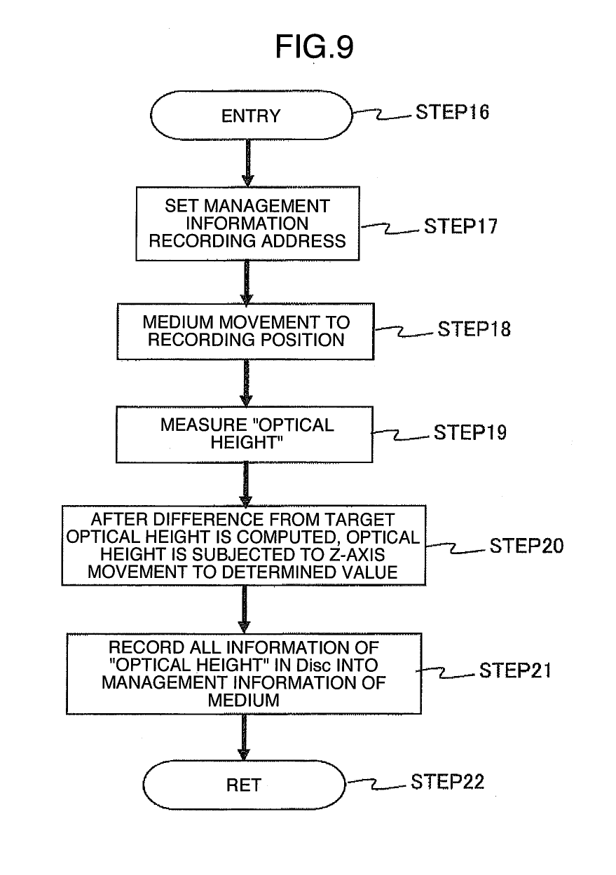

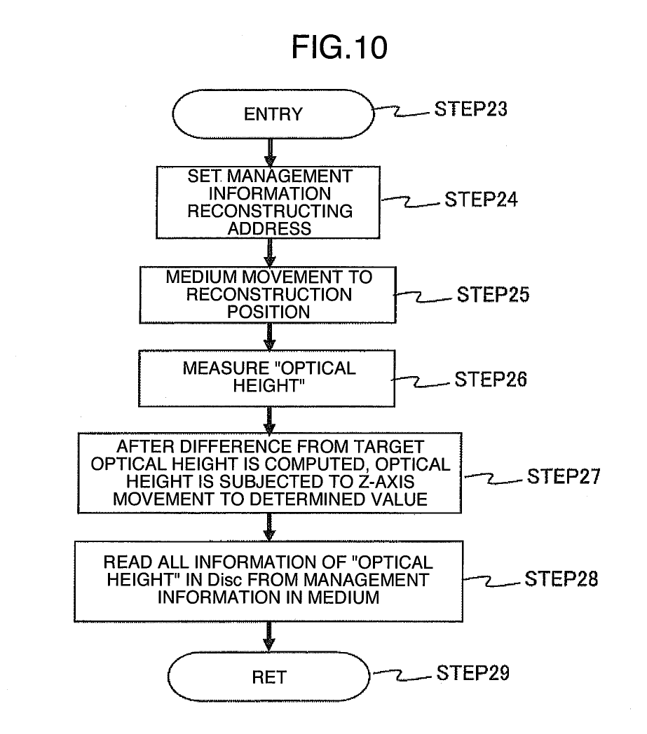

The operation flow of the case of recording of the above described second example is shown in FIG. 9, and the operation flow of the case of reconstructing is shown in FIG. 10. First, an address at which the management information of the medium 1 is recorded is set (STEP 17). Then, medium movement to the set address is carried out to complete positioning (STEP 18). Then, the optical height is measured (STEP 19); the difference between a target optical height and the measurement result of the optical height is computed, and the Z-axis is driven in accordance with the computing result (STEP 20); and all the information of the optical heights in the Disc is then subjected to batch recording as management information onto the medium (Step 21).

On the other hand, in the reconstructing operation of the management information, the reconstructing address at which the management information of the medium 1 is recorded is set (STEP 24), and medium movement to the reconstructing address is carried out to complete positioning (STEP 25). Then, the optical height is measured (STEP 26); the difference between a target optical height and the measurement result of the optical height is computed, and the Z-axis is driven in accordance with the computing result (STEP 27); and, then, all the information of the optical heights in the Disc is read from the management information in the Disc (STEP 28).

In the above described second example, the optical height information of the case of recording is recorded and reconstructed as the management information of the recording medium. As a result, the optical height information can be provided to physically correspond to the recording medium 1. The physical optical heights for recording and reconstructing the important management information are caused to be the same height in recording and reconstructing. As a result, the certainty of data writing and reading of recording and reconstructing can be improved. Moreover, in a state in which the reconstructing beam of the hologram is not obtained, defocusing adjustment of the case of reconstructing can be carried out.

The present invention is not limited to the above described examples, but includes various modifications. For example, the above described examples are explained in detail in order to understandably explain the present invention, and are not necessarily limited to be provided with all the explained configurations. Part of the configuration of a certain example can be replaced by the configuration of another example, and, to the configuration of a certain example, the configuration of another example can be also added. Moreover, part of the configurations of the examples can be subjected to addition/deletion/replacement of other configurations.

Part or all of the above described configurations, functions, processing units, processing means, etc. may be realized by hardware by, for example, designing by an integrated circuit. The above described configurations, functions, etc. may be realized by software by interpreting and executing a program(s) which realize the functions by a processor. The information of the programs, tables, files, etc. which realize the functions can be placed in a memory, a recording device such as a hard disk or an SSD (Solid State Drive), or a recording medium such as an IC card, an SD card, or a DVD.

Control lines, information lines which are conceived to be necessary in terms of explanation are shown, and all control lines and information lines in terms of product are not necessarily shown. In practice, almost all of the configurations may be conceived to be mutually connected.

### REFERENCE SIGNS LIST

1 . . . RECORDING MEDIUM, 11 . . . OPTICAL PICKUP, 12 . . . RECONSTRUCTING REFERENCE-BEAM OPTICAL SYSTEM, 101 . . . LIGHT SOURCE, 102 . . . COLLIMATE LENS, 103 . . . SHUTTER, 104 . . . ½-WAVELENGTH PLATE, 105 . . . POLARIZATION BEAM SPLITTER, 106 . . . SIGNAL BEAM, 107 . . . REFERENCE BEAM, 108 . . . BEAM EXPANDER, 109 . . . PHASE MASK, 110 . . . RELAY LENSES, 111 . . . POLARIZATION BEAM SPLITTER, 112 . . . SPATIAL LIGHT MODULATOR, 113 . . . RELAY LENSES, 114 . . . POLYTOPIC FILTER, 115 . . . OBJECTIVE LENS, 116 . . . POLARIZATION-DIRECTION CONVERTING ELEMENT, 117 . . . MIRROR, 118 . . . MIRROR, 119 . . . MIRROR, 120 . . . ACTUATOR, 121 . . . LENS, 122 . . . LENS, 123 . . . ACTUATOR, 124 . . . MIRROR, 125 . . . HOLOGRAM, 126 . . . DISTANCE METER, 127 . . . SPINDLE MOTOR, 128 . . . RADIAL MOVEMENT STAGE, 129 . . . PPF DRIVING UNIT, 130 . . . z-DISTANCE COMPUTING UNIT, 131 . . . Rθ DRIVING UNIT, 132 . . . MOVEMENT DISTANCE COMPUTING UNIT, 133 . . . MEMORY, 134 . . . MEDIUM MOVEMENT CONTROL UNIT, 135 . . . MEDIUM POSITION SPECIFYING UNIT, 136 . . . INPUT TERMINAL (RECONSTRUCTION MODE) 137 . . . INPUT TERMINAL (MEDIUM NUMBER), 138 . . . INPUT TERMINAL (ADDRESS), 139 . . . DATA PROCESSING UNIT, 140 . . . OUTPUT TERMINAL (RECONSTRUCTING SIGNAL), 141 . . . INPUT TERMINAL (RECORDING INFORMATION), 142 . . . RECONSTRUCTING SIGNAL PROCESSING UNIT, 143 . . . RECORDING SIGNAL PROCESSING UNIT, 144 . . . MEDIUM RECORDING PROCESSING UNIT, 145 . . . z DRIVING UNIT, 146 . . . Z-AXIS STAGE ACTUATOR, 150 . . . OPTICAL DETECTOR, 151 . . . ACTUATOR

1. An optical information recording and reconstructing device that records information by irradiating a recording medium with a signal beam and a reference beam and forming a hologram and reconstructs an information signal by irradiating the hologram of the recording medium with the reference beam; the optical information recording and reconstructing device comprising:
a laser light source;
a branching unit that causes an emitted beam from the laser light source to branch into the signal beam and the reference beam;
a spatial light modulating unit that adds the information signal to the signal beam;
an objective lens for irradiating the recording medium with the signal beam to which the information signal is added;
an optical detecting unit that detects diffraction light when the recording medium is irradiated with the reference beam; and
a distance measuring unit that measures a distance from a predetermined point of an optical structure unit including the objective lens to the recording medium; wherein
information about the distance in a case of recording is stored in the recording medium or a memory; and
reconstruction is carried out based on the stored information about the distance.

2. The optical information recording and reconstructing device according to claim 1, wherein
the information about the distance is information corresponding to a unique number of the recording medium.

3. The optical information recording and reconstructing device according to claim 1, wherein
the information about the distance is information corresponding to an area on the recording medium.

4. The optical information recording and reconstructing device according to claim 1, comprising
a filter that suppresses noise of the diffraction light; and
a driving unit that drives the filter; wherein
the driving unit drives the filter based on the information about the distance.

5. The optical information recording and reconstructing device according to claim 4, wherein
the distance measuring unit measures the distance in a case of reconstruction; and
the driving unit drives the filter based on information about the measured distance in the case of reconstruction and the information about the distance in the case of recording.

6. The optical information recording and reconstructing device according to claim 5, wherein
the driving unit drives the filter based on the information about a difference between the distance measured in the case of reconstruction and the distance in the case of recording.

7. The optical information recording and reconstructing device according to claim 4, wherein
the driving unit drives the filter in an optical axis direction.

8. The optical information recording and reconstructing device according to claim 1, wherein
the distance measuring unit measures a distance from the predetermined point of the optical structure unit including the objective lens to a surface of the recording medium.

9. The optical information recording and reconstructing device according to claim 3, wherein
the area on the recording medium is an area including a plurality of addresses.

10. The optical information recording and reconstructing device according to claim 1, comprising
a recording medium driving unit that moves the recording medium;
wherein
the recording medium driving unit drives the recording medium based on the information about the distance.

11. The optical information recording and reconstructing device according to claim 10, wherein
the recording medium driving unit drives the recording medium so that a difference from the distance from the predetermined point of the optical structure unit including the objective lens to the recording medium becomes a predetermined value or less.

12. The optical information recording and reconstructing device according to claim 1, wherein
the memory is provided in a case covering the recording medium, is built into the optical information recording and reconstructing device, or is comprised by a host connected to the optical information recording and reconstructing device.

13. The optical information recording and reconstructing device according to claim 1, wherein
the information about the distance in the case of recording is stored in a management information region of the recording medium.

14. The optical information recording and reconstructing device according to claim 4, wherein
the filter is driven in a period in which a reconstructing address is allocated to the recording medium and positioning of the recording medium is carried out with respect to the address.

15. A recording method of recording information by irradiating a recording medium with a signal beam and a reference beam and forming a hologram; including
a step of irradiating a laser beam;
a step of causing the laser beam to branch into the signal beam and the reference beam;
a step of adding an information signal to the signal beam;
a step of detecting diffraction light when the recording medium is irradiated with the reference beam;
a step of measuring a distance from a predetermined point of an optical structure unit including the objective lens to the recording medium; and
a step of storing information about the distance in a case of recording.
